(19) United States
(12) Patent Application Publication
(10) Pub. No.: US 2008/0074350 A1
(43) Pub. Date: Mar. 27, 2008

(54) HIGH-DEFINITION IMAGE DISPLAY DEVICE AND METHOD OF CONVERTING FRAME RATE THEREOF

(75) Inventors: Nam-kyun BEON, Seoul (KP); Jong-sul MIN, Hwaseong-si (KP); Byoung-hwa JUNG, Seongnam-si (KP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KP)

(21) Appl. No.: 11/736,234

(22) Filed: Apr. 17, 2007

(30) Foreign Application Priority Data
Sep. 26, 2006 (KR) 2006-93432

(51) Int. Cl. G09G 3/20

(52) U.S. Cl. 345/55

(57) ABSTRACT

A high-definition image display device and a method of converting a frame rate thereof are provided. The high-definition image display device includes an image processing unit which processes an input image signal, a first frame rate conversion (FRC) unit which receives an image signal from the image processing unit and generates first interpolated data by processing a first part of frame data of the image signal, and a second FRC unit which generates second interpolated data by processing a second part of the frame data of the image signal and outputs the second interpolated data to the first FRC unit, wherein the first and second interpolated data are combined by and output from the first FRC unit. Accordingly, clear pictures can be provided by converting the frame rate through processing of large capacity data according to the high resolution of the image display device, using a plurality of FRC circuits.

### CROSS-REFERENCE TO RELATED APPLICATION

This application claims priority from Korean Patent Application No. 10-2006-0093432, filed Sep. 26, 2006, in the Korean Intellectual Property Office, the disclosure of which is incorporated by reference in its entirety.

### BACKGROUND OF THE INVENTION

1. Field of the Invention

Apparatuses and methods consistent with the present invention relate to a high-definition image display device and a method of converting a frame rate thereof, and more particularly, to a high-definition image display device and a method of converting a frame rate thereof, which can provide clear pictures by converting a frame rate through an effective processing of large capacity data according to the high resolution of the image display device, using a plurality of frame rate conversion (FRC) circuits.

2. Description of the Related Art

Generally, a high-definition image display device is a display device having an improved definition, such as a high definition television (HDTV), in comparison to the existing image display device. Typically, a full HD-grade HDTV has a 1920×1080 p resolution, in which 60 pictures of a 1920×1080 resolution are shown per second.

To display a high-definition image, a high frame rate is required in addition to a high resolution. This is because picture-quality deterioration such as motion blurring can be improved by heightening the frame rate. Here, frame rate means the number of frames displayed on a screen per second.

However, since a vast amount of frame data to be processed is required to convert the frame rate due to the high resolution of the HDTV, the existing FRC circuits cannot be applied to the HDTV as they are.

For example, although 100-Hz/120-Hz FRC circuits that can support a Wide Extended Graphics Array (WXGA)-grade 1366×768 resolution have been developed, 1920×1080 resolution is required in the HDTV, and thus the frame rate should be converted by processing data that is twice as large as that of WXGA. Accordingly, it is impossible to use the WXGA-grade 100-Hz/120-Hz FRC circuits unless the size of hardware becomes doubled. In addition, although a clock processing speed reaching 300-MHz should be ensured on the basis of the 100-Hz FRC circuits supporting WXGA as the amount of data is increased, it is difficult to achieve such a processing speed through the use of the conventional FRC circuits.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. Accordingly, the present invention provides a high-definition image display device and a method of converting a frame rate thereof, which can provide clear pictures by converting a frame rate through an effective processing of large capacity data according to the high resolution of the image display device, using a plurality of FRC circuits.

The foregoing and other objects and advantages are substantially realized by providing a high-definition image display device, which comprises an image processing unit for processing an input image signal; a first FRC unit which receives an image signal from the image processing unit and generates first interpolated data by processing a first part of frame data of the image signal; and a second FRC unit which generates second interpolated data by processing a second part of the frame data of the image signal and outputs the second interpolated data to the first FRC unit; wherein the first and second interpolated data are combined by and output from the first FRC unit.

The first FRC unit and the second FRC unit may comprise FRC circuits for converting the input image signal having a frame rate of 50-Hz, 60-Hz, or 70-Hz into an output image signal having a frame rate of 100-Hz, 120-Hz, or 150-Hz.

The first FRC unit and the second FRC unit may generate the interpolated data by motion estimation and motion compensation.

The image display device may further comprise an FRC selection control unit which controls whether to operate the first FRC unit and the second FRC unit.

The image display device may further comprise a display panel driving unit which receives the output signal of the first FRC unit; and a display panel driven by the display panel driving unit.

The first interpolated data may be generated by processing the first half and a part of the latter half of the frame data, and the second interpolated data may be generated by processing the latter half and a part of the first half of the frame data.

The image display device may further comprise a multiplexer (MUX) for combining the first and second interpolated data, separating the combined data into odd data and even data, and outputting the separated odd and even data.

The MUX may be provided in the first FRC unit.

The first FRC unit may further comprise a first-in first-out (FIFO) unit which temporarily stores the data generated from the second FRC unit so that the data generated from the first and second FRC units are output in order.

According to another aspect of the present invention, there is provided a method of converting a frame rate of a high-definition image display device, which comprises generating first interpolated data by processing a first part of frame data of an image signal; generating second interpolated data by processing a second part of the frame data of the image signal; and combining and outputting the first and second interpolated data.

The first and second interpolated data may be generated using FRC circuits for converting the input image signal having a frame rate of 50-Hz, 60-Hz, or 75-Hz into an output image signal having a frame rate of 100-Hz, 120-Hz, or 150-Hz.

The first and second interpolated data may be generated by motion estimation and motion compensation.

The method of converting a frame rate of a high-definition image display device may further comprise selecting whether to generate the first and second interpolated data to be executed.

The first interpolated data may be generated by processing the first half and a part of the latter half of the frame data, and the second interpolated data may be generated by processing the latter half and a part of the first half of the frame data.

The combined interpolated data may be separated into odd data and even data to be output.

The method of converting a frame rate of a high-definition image display device may further comprise temporarily storing the second interpolated data so that the first and second interpolated data are output in order.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a block diagram illustrating a high-definition image display device according to an exemplary embodiment of the present invention;

FIG. 2 is a view illustrating a method of generating interpolated frames according to an exemplary embodiment of the present invention;

FIG. 3 is a block diagram illustrating first and second FRC units according to an exemplary embodiment of the present invention;

FIG. 4 is a view illustrating frame data processing regions of the first and second FRC unit according to an exemplary embodiment of the present invention;

FIG. 5 is a block diagram illustrating the first FRC unit according to an exemplary embodiment of the present invention; and

FIG. 6 is a flowchart illustrating a process of converting a frame rate according to an exemplary embodiment of the present invention.

### DETAILED DESCRIPTION OF EXEMPLARY EMBODIMENTS OF THE INVENTION

Exemplary embodiments of the present invention will now be described in detail with reference to the annexed drawings. In the drawings, the same elements are denoted by the same reference numerals throughout the drawings. In the following description, detailed descriptions of known functions and configurations incorporated herein have been omitted for conciseness and clarity.

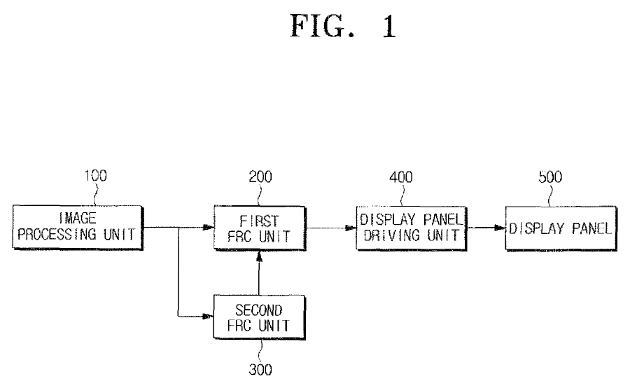

FIG. 1 is a block diagram illustrating a high-definition image display device according to an exemplary embodiment of the present invention.

First, an input signal is processed by an image processing unit 100.

A first FRC unit 200 receives an image signal processed by the image processing unit 100 and generates first interpolated data by processing a first part of frame data of the received image signal. In addition, the first FRC unit 200 combines second interpolated data generated by a second FRC unit 300 to be described later with the first interpolated data to output the combined interpolated data. Here, the frame rate of the image signal input to the first FRC unit 200 is 50-Hz in the case of a Phase Alternating Line (PAL) television system, while it is 60-Hz in the case of a National Television System Committee (NTSC) television system.

The interpolated data corresponds to data of an interpolated frame generated between two frames and is generated by motion estimation and motion compensation.

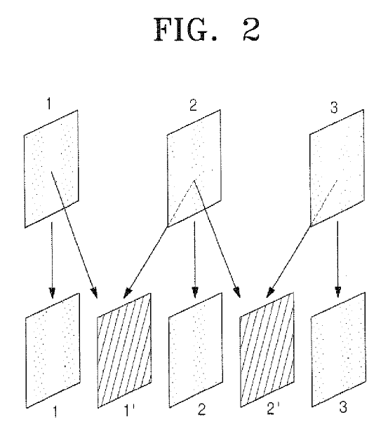

FIG. 2 is a view illustrating a method of generating interpolated frames according to an exemplary embodiment of the present invention. As shown in FIG. 2, interpolated frames 1′ and 2′ are generated using adjacent frames among the original frames 1, 2, and 3.

The second FRC unit 300 generates the second interpolated data by processing a second part of the frame data of the image signal and outputs the generated interpolated data to the first FRC unit 200.

A display panel driving unit 400 receives the output signal of the first FRC unit and drives a display panel 500 in accordance with the received signal.

In addition, an FRC selection control unit (not illustrated) which selectively controls the operation of the first and second FRC units 200 and 300 may be installed in a main board.

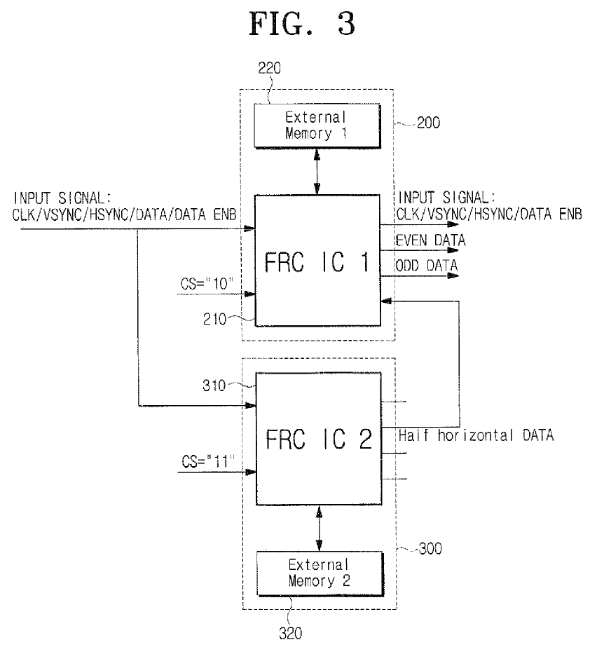

FIG. 3 is a block diagram illustrating the first and second FRC units according to an exemplary embodiment of the present invention.

The first FRC unit 200 comprises an FRC integrated circuit (IC) 1 210 and an external memory 1 220. Here, the FRC IC 1 is an FRC circuit for converting the input image signal having a frame rate of 50-Hz, 60-Hz, or 70-Hz into an output image signal having a frame rate of 100-Hz, 12-0 Hz, or 150-Hz. The external memory stores data of the present frame and a frame to be compared with the present frame when the interpolated data is calculated by motion estimation and motion compensation. A synchronous dynamic random access memory (SDRAM) or double data rate (DDR) may be used as the external memory.

In FIG. 3, “CS” denotes a set mode of the FRC selection control unit, and may have a value of “0X”, “10”, or “11”. In the case where CS is set to “0X”, only one of the first and second FRC units is operated irrespective of the set value of “00” or “01”. In this case, the high-definition image display device according to the present invention can be used as a WXGA television having a resolution lower than that of the HDTV, in addition to the full HD-grade HDTV. In other words, when “CS” is set to “0X”, the data can be processed only by one FRC circuit, and in order to generate the interpolated data, only the first FRC unit is operated, while the second FRC circuit is not operated.

As shown in FIG. 3, if CS=“10”, it represents a set mode for the FRC selection control unit for driving the FRC IC 1 210 of the first FRC unit 200, and if CS=“11”, it represents a set mode for the FRC selection control unit for driving the FRC IC2 310 of the second FRC unit 300. Accordingly, when CS is set to “10” and “11”, both the first and second FRC units 200 and 300 are operated to implement a full HD resolution. The second interpolated data generated by the second FRC unit 300 is output to the first FRC unit 200.

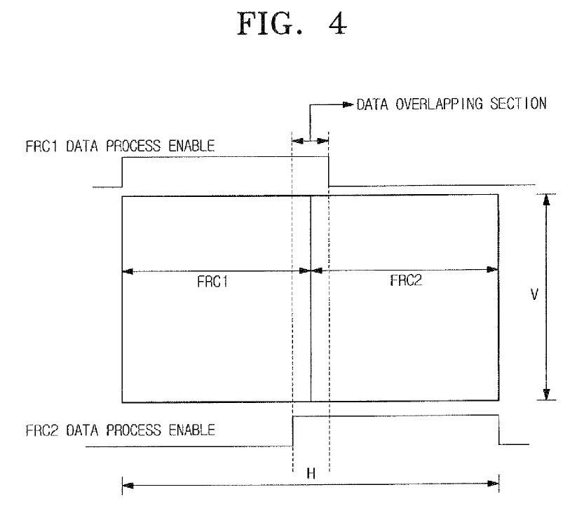

FIG. 4 shows regions of frame data processed by the two FRC units 200 and 300 when both the FRC units as shown in FIG. 3 are driven. The first and second FRC units 200 and 300 process parts of the frame data in order to generate first and second interpolated data. As shown in the drawing, the first FRC unit 200 processes the first half and a part of the latter half of the frame data in order to generate the first interpolated data corresponding to the first half of the interpolated frame. In the drawing, the first half and a part of the latter half of the frame data are indicated as FRC1 data process enable.

The second FRC unit 300 processes the latter half and a part of the first half of the frame data in order to generate the second interpolated data corresponding to the latter half of the interpolated frame. The first and second FRC units process the frame data in order to make a data overlapping section of a predetermined length is to ensure the continuity of motion vectors during motion estimation in the unit of a block.

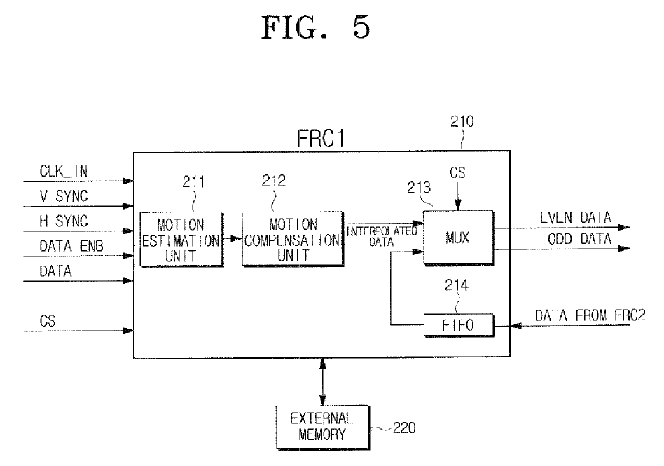

FIG. 5 is a block diagram illustrating the first FRC unit according to an exemplary embodiment of the present invention.

Referring to FIG. 5, the first FRC unit 200 comprises a motion estimation unit 211, a motion compensation unit 212, a multiplexer (MUX) 213, and a first-in first-out (FIFO) unit 214. The first interpolated data is generated through the motion estimation unit 211 and the motion compensation unit 212. The MUX 213 multiplexes the first interpolated data and the second interpolated data generated by the second FRC unit 300, and separates the multiplexed interpolated data into odd data and even data to output the separated odd data and even data.

The FIFO 214 temporarily stores the data generated by the second FRC unit 300 in order to output the first and second interpolated data in order.

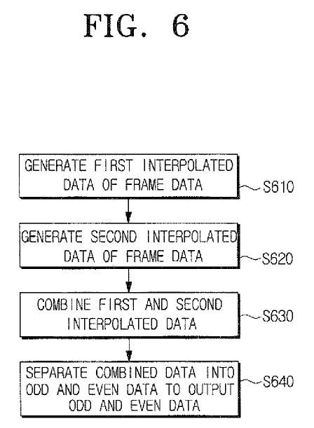

FIG. 6 is a flowchart illustrating a process of converting a frame rate according to an exemplary embodiment of the present invention.

The first interpolated data is generated by processing one part of the frame data of the image signal (S610), and the second interpolated data is generated by processing the other part of the frame data (S620). The two generated interpolated data are multiplexed (S630), and the multiplexed interpolated data is separated into odd data and even data (S640).

The first interpolated data corresponding to the first half of the interpolated frame is generated by processing the first half and a part of the latter half of the frame data, and the second interpolated data corresponding to the latter half of the interpolated frame is generated by processing the latter half and a part of the first half of the frame data.

Here, the interpolated data are generated using FRC circuits for converting the input image signal having the frame rate of 50-Hz, 60-Hz, or 75-Hz into an output image signal having the frame rate of 100-Hz, 120-Hz, or 150-Hz, and motion estimation and motion compensation methods.

In the exemplary embodiments of the present invention, a full HD image display device has been exemplified. However, it is apparent that the present invention can also be applied to a high-definition image display device having a resolution above the full HD. Also, in the exemplary embodiments of the present invention, it has been exemplified that the high-definition image display device employs two FRC units. However, the present invention is not limited thereto, and the high-definition image display device may comprise more than two FRC units.

As described above, according to the high-definition image display device and the method of converting the frame rate thereof of the present invention, clear pictures can be provided by converting the frame rate through an effective processing of large capacity data according to the high resolution of the image display device, using a plurality of FRC circuits.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A high-definition image display device comprising:
an image processing unit for processing an input image signal;
a first frame rate conversion (FRC) unit which receives an image signal from the image processing unit and generates first interpolated data by processing a first part of frame data of the image signal; and
a second FRC unit which generates second interpolated data by processing a second part of the frame data of the image signal and outputs the second interpolated data to the first FRC unit;
wherein the first and second interpolated data are combined by and output from the first FRC unit.

2. The high-definition image display device of claim 1, wherein the first FRC unit and the second FRC unit comprise FRC circuits for converting the input image signal having a frame rate of 50-Hz, 60-Hz, or 70-Hz into an output image signal having a frame rate of 100-Hz, 120-Hz, or 150-Hz.

3. The high-definition image display device of claim 1, wherein the first FRC unit and the second FRC unit generate the interpolated data by motion estimation and motion compensation.

4. The high-definition image display device of claim 1, further comprising an FRC selection control unit which controls whether to operate the first FRC unit and the second FRC unit.

5. The high-definition image display device of claim 1, further comprising:
a display panel driving unit which receives an output signal of the first FRC unit; and
a display panel which is driven by the display panel driving unit.

6. The high-definition image display device of claim 1, wherein the first interpolated data is generated by processing a first half of the frame data and a part of a second half of the frame data, and the second interpolated data is generated by processing the second half of the frame data and a part of the first half of the frame data.

7. The high-definition image display device of claim 6, further comprising a multiplexer (MUX) for combining the first and second interpolated data, separating the combined data into odd data and even data, and outputting the separated odd and even data.

8. The high-definition image display device of claim 7, wherein the MUX is provided in the first FRC unit.

9. The high-definition image display device of claim 7, wherein the first FRC unit further comprises a first-in first-out (FIFO) unit which temporarily stores the second interpolated data generated by the second FRC unit so that the first interpolated and second interpolated data generated by the first and second FRC units, respectively, are output in order.

10. A method of converting a frame rate of a high-definition image display device, the method comprising:
generating first interpolated data by processing a first part of frame data of an image signal;
generating second interpolated data by processing a second part of the frame data of the image signal; and
combining and outputting the first and second interpolated data.

11. The method of claim 10, wherein the first and second interpolated data are generated using frame rate conversion (FRC) circuits for converting the input image signal having a frame rate of 50-Hz, 60-Hz, or 70-Hz into an output image signal having a frame rate of 100-Hz, 120-Hz, or 150-Hz.

12. The method of claim 10, wherein the first and second interpolated data are generated by motion estimation and motion compensation.

13. The method of claim 10, further comprising selecting whether to generate the first and second interpolated data.

14. The method of claim 10, wherein the first interpolated data is generated by processing a first half of the frame data and a part of a second half of the frame data, and the second interpolated data is generated by processing the second half of frame data and a part of the first half of the frame data.

15. The method of claim 14, wherein the combined interpolated data is separated into odd data and even data to be output.

16. The method of claim 15, further comprising temporarily storing the second interpolated data so that the first and second interpolated data are output in order.
